(19) United States
(12) Patent Application Publication
(10) Pub. No.: US 2023/0085159 A1
(43) Pub. Date: Mar. 16, 2023

(54) APPARATUS AND METHOD FOR AUTOMATED MANUFACTURING OF MAGNETIC STRUCTURES AS RARE-EARTH REPLACEMENTS

(71) Applicant: Weinberg Medical Physics Inc, North Bethesda, MD (US)

(72) Inventors: Irving N. WEINBERG, North Bethesda, MD (US); Sahar JAFARI CHAMKAVI, North Bethesda, MD (US); Lamar Odell MAIR, Baltimore, MD (US); Oleg UDALOV, North Bethesda, MD (US)

(21) Appl. No.: 17/945,756

(22) Filed: Sep. 15, 2022

Related U.S. Application Data
(60) Provisional application No. 63/244,686, filed on Sep. 15, 2021.

(51) Int. Cl. H01F 41/26; C25D 1/00

(52) U.S. Cl. CPC H01F 41/26; C25D 1/003

(57) ABSTRACT

An apparatus and method of fabricating magnetic structures utilizing nanocomposites to build bulk magnetic materials, with controlled magnetic alignments are provided. The method includes application of an editing tool, such as a laser, for patterning an editable structure that mounted on an electrically conductive substrate and filling the pattern with solid materials to create the magnetic structures.

### CROSS REFERENCE AND PRIORITY CLAIM

This application claims priority to U.S. Provisional patent application Ser. No. 63/244,686, entitled “Apparatus and method for automated manufacturing of magnetic structures as rare-earth replacements” filed Sep. 15, 2021, the entirety of which is incorporated by reference.

### FIELD

Disclosed embodiments are directed to an apparatuses and methods of fabricating magnetic composite structures. In particular, disclosed embodiments describe a method and apparatus for utilizing nanocomposites to build bulk magnetic materials, with controlled magnetic alignments.

### BACKGROUND

Yue et al showed that nanocomposite powders could be consolidated into bulk magnets. In microscopic-sized thin-film samples, the (BH)max attained was as high as 61 MGOe, which is higher than available for conventional alloy magnets. Similarly, E. Lottini et al, “Strongly Exchange Coupled Core Shell Nanoparticles with High Magnetic Anisotropy: A Strategy toward Rare-Earth-Free Permanent Magnets”, Chem. Mater. 2016, 28, 4214-4222, prepared nanoscale core-shell structures with high energy storage capability. In both the above and other publications, magnetic alignment problems occurred when attempting to create bulk forms of the nanocomposite materials.

Hard magnetic materials find use in many industrial applications, including electric motors and generators. For such applications, high magnetic remanence and high Curie temperature are both desirable characteristics of the magnet. Bulk alloys, as well as microstructure-engineered materials have been proposed as various hard magnetic materials for electric motors. While NdFeB magnets maintain large remanence and energy product, they suffer from low Curie temperatures. Other materials that may be used in electric motors include ferrite, AlNiCo, and SmCo, as well as other more exotic magnetic materials. The bulk properties of magnets are due to interactions between grains at the nano-scale level. Some investigators have shown that nano-scale particles or layers composed of different materials can be engineered to have specific magnetic properties. However, as described in Y. Ming, X. Zhang and J. P. Liu, “Fabrication of bulk nanostructured permanent magnets with high energy density: challenges and approaches”, Nanoscale, 2017, DOI: 10.1039/C6NR09464C., it is challenging to build bulk magnets from those nanoscale structures. Disclosed embodiments describe an apparatus and method of implementing nano-scale magnetic properties into bulk-sized structures useful for industrial applications.

### SUMMARY

Disclosed embodiments include apparatuses and methods of fabricating structures containing at least one electrically conductive segment and at least one magnetic segment at one time during the fabrication process. Patterns may be formed in an editable structure using an editing tool to pattern the editable structure. Hollow portions in at least one of the generated patterns are filled entirely or partially by solid materials at least in part via electrodeposition from electrically conductive fluids, gases, or plasmas using the electrode structure as an electrode, and magnetic materials are deposited onto the solid materials, the, wherein magnetic materials constitute produced magnetic structures

### BRIEF DESCRIPTION OF THE FIGURES

Aspects and features of the disclosed embodiments are described in connection with various figures, in which:

FIG. 1 illustrates an embodiment of the apparatus according to the disclosed embodiments;

FIG. 2 illustrates another embodiment of the apparatus according to the disclosed embodiments;

FIG. 3 illustrates an embodiment of the magnetic structure apparatus produced by the components of the apparatus illustrated in FIGS. 1 and/or 2;

FIG. 4 illustrates an embodiment of the magnetic structure apparatus produced according to disclosed methods;

FIG. 5 illustrates an embodiment of the method of making a magnetic structure apparatus according to the disclosed embodiments;

FIG. 6 illustrates an embodiment of the method of making a magnetic structure apparatus according to the disclosed embodiments; and

FIG. 7 illustrates an embodiment of the method of making a magnetic structure apparatus according to the disclosed embodiments.

### DETAILED DESCRIPTION

The present invention will now be described in connection with one or more embodiments. It is intended for the embodiments to be representative of the invention and not limiting of the scope of the invention. The invention is intended to encompass equivalents and variations, as should be appreciated by those skilled in the art.

The disclosed apparatus includes novel components and novel methods required to produce a novel magnetic structure, and the novel magnetic structure itself (termed “produced structure”). Apparatuses and methods for fabricating structures containing at least one electrically conductive segment and at least one magnetic segment at one time during the fabrication process are shown and described.

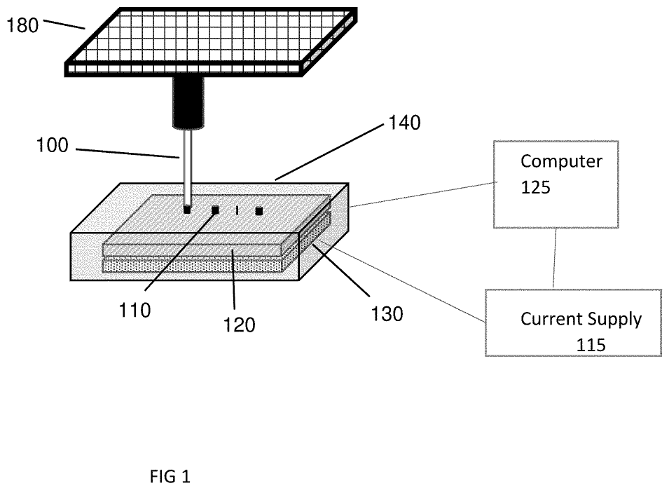

FIG. 1 illustrates an embodiment of the apparatus of the disclosed embodiments. As shown in FIG. 1, a laser beam 100 (or other editing or cutting tool) is applied to create holes or other patterns 110 in a mask structure 120, the mask structure being in close proximity (for example, within 100 microns) or contact to electrode structure 130. As seen in FIG. 1, the editing tool (for example laser beam 100) forms a pattern 110 on the editable structure 120. The editable structure 120 that may be mounted on an electrically conductive structure 130 that is connected to a potentiostat or other current and voltage-controlling supply of electrical current 115, which may be controlled by computer 125. Structures 120 and 130 may be within a container 140, which may also contain an editing tool such as the laser that produces laser beam 100, and may also contain beam-forming and beam-directing elements (for example, lenses and mirrors) and may also contain means (for example, motors, pulleys) for moving the laser and beam-forming and beam-directing elements, all under control of a computer 125.

In an embodiment, the laser beam 100 may be generated from a laser that is mounted on a two- or three-dimensional motorized gantry 180 that enables micromanipulation of the position of the laser beam 100. In an embodiment of the apparatus, the laser beam 100 may be sent through an aperture or an objective or lens (not shown) for modifying the diameter, spot size, or focus of the laser beam 100. Container 140 may contain heating and/or cooling elements and thermometers, under computer control 125. Some or all of the above structures may be within a container 140. Container 140 may be connected to the source of electrical current. Electrode structure may include titanium, copper, or other electrically conductive materials. The laser beam 100 may be attached to a motorized gantry 180 for lateral and vertical manipulation of the laser position. The laser beam 100 may be sent though optics, such as apertures and lenses, which may be computer controlled (for example, spatial light modulators) for modification of the laser beam prior to it impinging on the mask structure 120.

It is understood that laser beam 100 may be composed of beams from multiple lasers whose separate beams may intersect in the mask at the same time or at different times. It is understood that such intersection may be used as a means to alter the editable structure 120 only at the site at which the beams intersect. Such an embodiment may result in a narrower or otherwise different pattern in the editable structure 120 than could be obtained with a single laser beam or other type of editing tool.

An electrical field may be established (for example by attaching an electrode to the substrate and applying a current pulse) to assist in forming or shaping the editable structure, similar to processes used in electrodischarge machining (EDM). The laser beam or other editing tool (for example, an electrode needle acting as a discharge-forming electrode) may start a spark or other electrical discharge that then forms a pore through the mask to reach the substrate. The pore may be enlarged or otherwise modified by the laser beam, or through an etching process.

It is understood that the terms “editable” and “mask”, used interchangeably in this description, implies that material within the mask structure can be removed with application of energy or chemicals. It is understood that although for purposes of illustration, structures 120 and 130 are shown as separate structures, they may constitute one structure that has both mask properties and electrode properties in the same or different sections.

In FIG. 1, mask structure 120 may be a tape that is attached to electrode structure 130 via adhesive. In an embodiment, mask structure 120 and/or electrode structure 130 may be ribbons originally stored on bobbins in a roll-to-roll arrangement.

It is understood that mask structure 120 and/or electrode structure 130 may move, for example by rotation or translation.

It is understood that heat or other annealing processes may be applied to the produced structures in order to change their properties, and that such processes may be applied within the container 230 or after removal of the produced structures from the container. A heating element (not shown) may be present within the container to effect said heating.

For the purposes of this specification, the terms “substrate structure” and “electrode structure” are used interchangeably, since at least some portion of the substrate structure may act as an electrode in deposition steps.

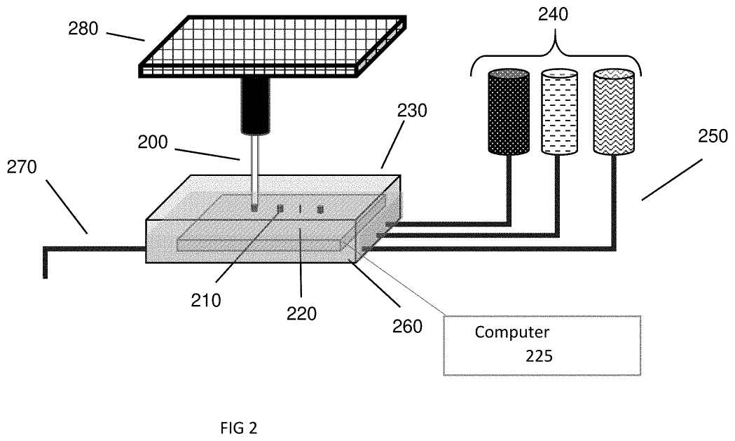

As shown in the embodiment illustrated in FIG. 2, the mask structure 210 may be formed from a fluid that has been deposited on an electrode structure 220. Patterns in the mask may be created by laser beam 200. Fluid 260 may have been deposited from one or more containers 240 via a computer-controlled transport mechanism 250. At least one fluid may contain a surfactant, which has been shown to assist in removing produced structures (as taught by M. Moravej et al, “Electroformed iron as new biomaterial for degradable stents”, Acta Biomateriala, Volume 6, Issue 5, May 2010). Transport mechanism 250 may be tubes and/or fluidic channels. Fluid 260 may be contained in container 230. Laser beam 200 may be applied while fluid is present in container 230, for example to reduce heat load applied to structure 220.

. In operation, a laser beam 200 may form a pattern 210 on a substrate structure 220. The substrate structure 220 may contain an electrically conductive segment that is connected to a potentiostat or other current- and/or voltage-controlling supply of electrical current 235. Substrate structure 220 may be within a container 230. The container 230 may also contain the laser that produces laser beam 200, beam-forming and beam-directing elements (for example, lenses and mirrors), and/or means (for example, motors, pulleys) for moving said laser and beam-forming and beam-directing elements (for example, spatial light modulators, lenses, prisms), some or all under of which are under control of a computer 225. The laser beam 200 may be moved with high precision (for example submicron) using the motorized gantry 280. One or more supply holders 240 may be used to fill some or all of container 230 with fluids, gases, or plasmas, the fluids, gases, or plasmas may contain materials to be deposited via electroplating or otherwise on structure 220, or the fluids used to cool structure 220, or fluids to enable removal or cleaning of structure 220 or other structures, or for some other purpose. Transport means (for example, tubes) 250 may be used to transport said fluids, gases or plasmas. Fluid 260, sent from the supply holders 240 into the container 230 via transport means 250, is illustrated as partially filling container 230. A handling system which measures volumes of fluids, gases, or plasmas dispersed by the supply holders 240 is integrated (not shown), and fluid exit system 270 ensures that the container 230 can be emptied and rinsed when necessary. Materials from supply holders 240 may be added to the container 260 at any point before, during, or after the process of forming a pattern 210 or the process of electroplating. During the patterning or electroplating process, transport means such as tubes 250 may be used to flow fluids or gases from supply holders 240 into the container 260 so as to modify concentrations in real time during patterning or deposition processes. The process of adding fluids or gases from supply holders 240 to the container 260 during patterning or electroplating processes may occur while simultaneously draining the container 260 using the fluid exit system 270. In an embodiment, such processes may be performed while the fluid exit system 270 remains inactive (i.e., no fluids are exiting the system).

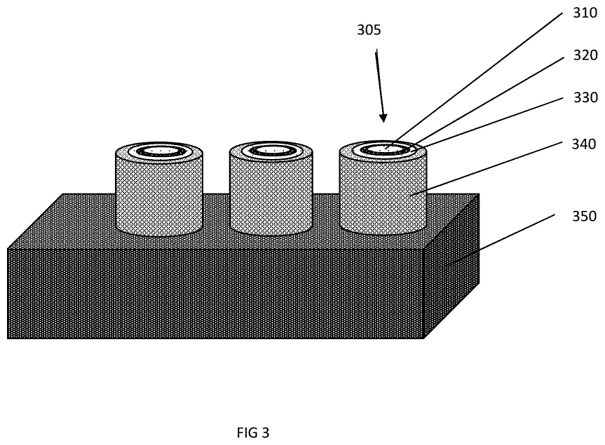

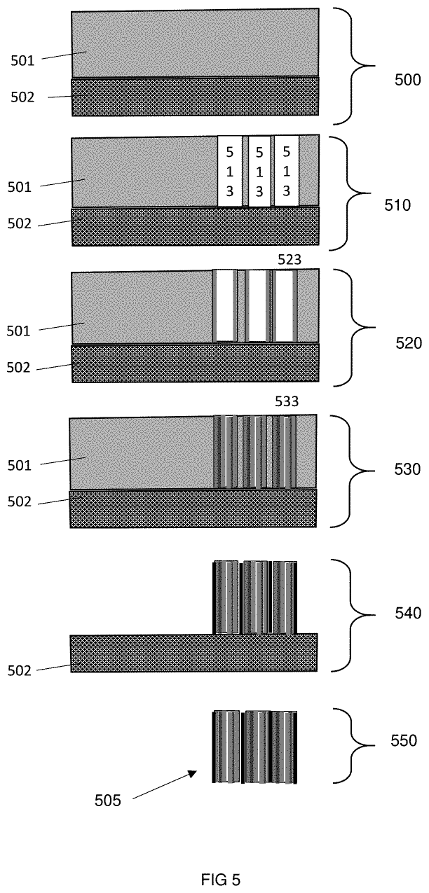

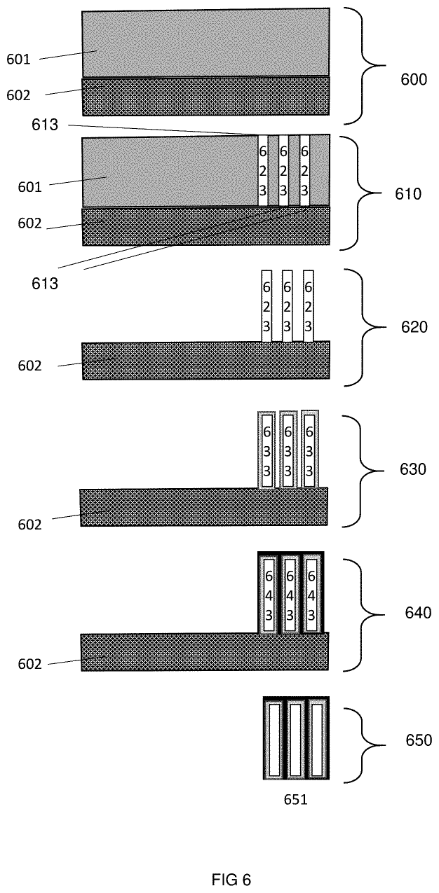

FIG. 3 illustrates an embodiment of the magnetic structure 305 that may be produced by the components of the apparatus illustrated in FIGS. 1 and/or 2, using the method of FIG. 5. In FIG. 3, the substrate structure 130 of FIG. 1 or 2 is present, as 350. However the substrate can be removed, as shown in FIG. 5. The pattern 110 that was constructed in the editable structure 120 with the apparatus shown in FIG. 1 was a set of holes. The sidewalls of the holes were coated with an electrically conductive material 340. Additional materials were deposited (for example, with nanoscale resolution) inside the original electrically conducting material 340. Growing inwards from electrically conducting material 340, conducting layers 330, 320, and 310 may each be deposited sequentially (in that order), by electrodeless deposition or electrodepositing electrically conducting layer 330 onto electrically conductive sidewall material 340, followed by electrically conducting layer 320 on 330, and likewise for layer 310. The multilayered composite material formed resembles a set of columns with concentric sections, like the rings of a tree, where the trees rings or layers may be composed of different materials or different alloys. The same apparatus of FIG. 3 could be formed in an alternative method (as shown, for example, in FIG. 6). The concentric rings shown in FIG. 3 may have cross-sectional shapes that are not circular, as shown, but rather square-shaped, rectangular, triangular, asymmetric, or customized/amorphous. The shapes could change with height.

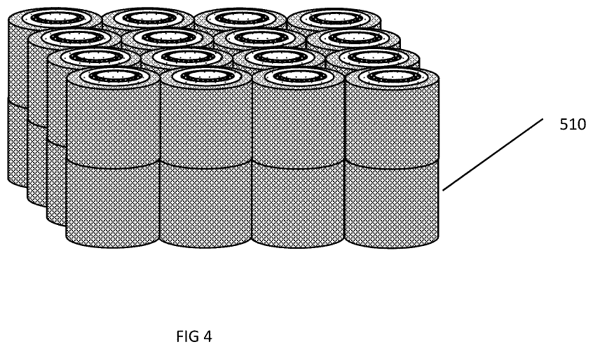

FIG. 4 illustrates an embodiment of the magnetic structure 510 produced by successive applications of the methods of FIGS. 5 and/or 6. In these successive applications, layers may be built on top of one another. Materials can be successively deposited to result in the structures shown in FIG. 3 and FIG. 4. For example, in FIG. 4 the lower layer may be deposited through the methods illustrated in FIGS. 5-7, and then coated with a mask to deposit another upper layer, and this process may be repeated to result in macroscopic (e.g., centimeter-scale) structures. In an embodiment, layers of non-conducting and conducting materials may be applied to the lower layer before adding an upper layer, and this process may again be repeated. It is understood that the material compositions may also be tuned, graded, or adjusted during the deposition process of an individual layer so as to engineer concentration gradients, microstructural changes, engineered surfaces for interfacial engineering, or other materials characteristics within a single layer as well as between layers.

FIG. 5 illustrates an embodiment of the method of the forming a magnetic structure. In operation 500, a mask structure (i.e., of editable material) 501 is deposited or mounted on a substrate structure 502, which may act as an electrode in further deposition operations. In operation 510, a laser beam or other editing tool may be been applied to the mask structure 501 to form a set of cavities and/or other hollow patterns. The term hollow implies that some or all of the pattern may be subsequently filled in by a material. The cavities may form cylindrical holes 513 as shown in FIG. 5. Note that mask structure 501 is still mounted on an electrode structure 502. The cavities are formed so that when an electrically conductive fluid (the fluid containing material to be deposited) is applied to mask structure 501, electrical contact is made to at least one portion of electrode structure 502. In operation 520, a process has been used to coat the sidewalls of the cylindrical holes 513, forming conducting sidewall material 523 \ (similar to material component 340 in FIG. 3). Following formation of the conducting sidewall materials 523, electrical current is applied to electrode structure 502 so that electrically conductive material(s) 523 (with magnetic properties) are deposited in the previously-created cavities. A primer may be previously applied to the walls of the cavities to assist in deposition of conductive material 523 in operation 520. In operation 530, another conductive material 533, with different magnetic properties than material 523, is applied. Some of the above operations may be repeated to deposit additional layers. In operation 540, the mask material is removed. Additional conductive materials with magnetic properties that may differ from prior layers may be applied at this point. In operation 550, the substrate has been removed, either by etching, mechanical force application, filing, scraping or some other method, now leaving a bulk magnetic structure 505.

FIG. 6 illustrates an embodiment of the method according to the disclosed embodiments. In operation 600, a mask structure (i.e., of editable material) 601 is deposited or mounted on a substrate structure 602, which may act as an electrode in further deposition steps. In operation 610, a laser beam has been applied to the mask structure 601 to form cavities 613 and/or other hollow patterns. The term hollow implies that some or all of the pattern may be subsequently filled in by a material. The cavity may form cylindrical holes as shown in FIG. 6. Note that mask structure 601 is still mounted on an electrode structure 602. The cavities are formed so that when an electrically conductive fluid (the fluid containing material to be deposited) is applied to mask structure 601, electrical contact is made to at least one portion of electrode structure 602. In operation 610, electrical current is applied to the electrode structure 602 so that electrically conductive material(s) 623 (possibly with magnetic properties) are deposited to form columns or other structures. A primer may have been previously applied to the walls of the columns to assist in deposition of conductive material 623 in operation 610. In operation 620, mask material 601 has been removed while leaving the columns of conductive material 623 attached to substrate 602. In operation 630, a conductive material 633 (possibly with different magnetic properties than 623) is applied. Some of the above steps may be repeated to deposit additional layers. In operation 640, additional conductive or other materials (with magnetic properties that may differ from prior layers) may be applied. In operation 650, the substrate has been removed, either by etching, mechanical force application, filing, scraping or some other method now leaving a bulk magnetic structure 651.

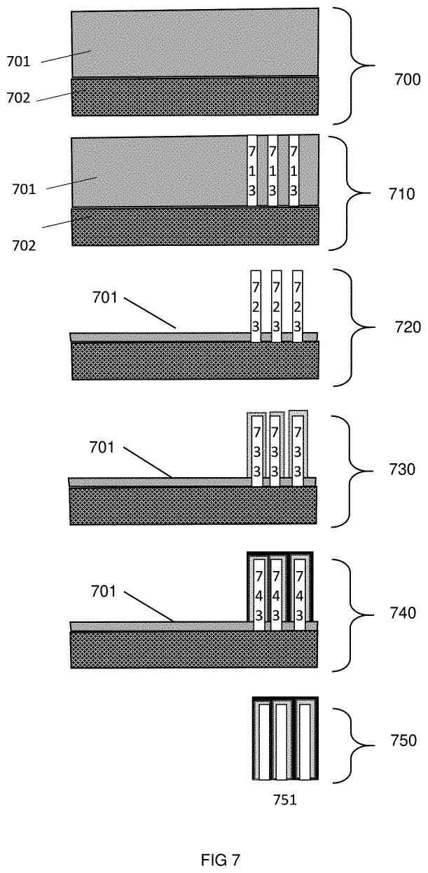

FIG. 7 illustrates an embodiment of the method of forming a magnetic structure apparatus similar to that shown in FIG. 6, with a modification. In operation 700, a mask structure (i.e., of editable material) 701 is deposited or mounted on a substrate structure 702. Substrate structure 702 may act as an electrode in further deposition operations. In operation 710, a laser beam has been applied to the mask structure 701 to form cavities 713 and/or other hollow patterns. The term hollow implies that some or all of the pattern may be subsequently filled in by a material. The cavity may form cylindrical holes as shown in FIG. 7. Note that mask structure 701 is still mounted on an electrode structure 702. The cavities 713 are formed so that when an electrically conductive fluid (said fluid containing material to be deposited) is applied to mask structure 701, electrical contact is made to at least one portion of electrode structure 702. Also represented in operation 710, electrical current is applied to the electrode structure 702 so that electrically conductive material(s) 723 (possibly with magnetic properties) are deposited to form columns or other structures. In operation 720, mask structure 701 has been removed in part and/or replaced with a thinner mask layer 721 of either the same or a different material as mask structure 701, leaving the columns 723 attached to the substrate structure 702. The columns 723 are partially exposed and available as conducting surfaces for subsequent electroplating. In operation 730, a conductive material (possibly with different magnetic properties than 723) is applied so that the columns are now composites 733. Some of the above steps may be repeated to deposit additional layers. In operation 740, another material is electrodeposited onto the columns 733, forming multi-layered columns 743. In operation 750, the columns 743 are separated from substrate 702. Additional conductive materials (with magnetic properties that may differ from prior layers) may be applied at this point. The substrate 702 may have been removed, either by etching, mechanical force application, filing, scraping or some other method now leaving a bulk magnetic structure 751.

FIG. 7 illustrates an embodiment of the method of the disclosed embodiments similar to that shown in FIG. 6, with a modification. In Step 700, a mask structure (i.e., of editable material) 701 is deposited or mounted on a substrate structure 702. Substrate structure 702 may act as an electrode in further deposition steps. In step 710, a laser beam has been applied to the mask structure (now called 711) to form cavities 713 and/or other hollow patterns. The term hollow implies that some or all of the pattern may be subsequently filled in by a material. The cavity may form cylindrical holes as shown in FIG. 7. Note that mask structure (now called 711) is still mounted on an electrode structure (now called 712). The cavities 713 are formed so that when an electrically conductive fluid (said fluid containing material to be deposited) is applied to mask structure 711, electrical contact is made to at least one portion of electrode structure 712. Also represented in step 710, electrical current is applied to the electrode structure 712 so that electrically conductive material(s) 713 (possibly with magnetic properties) are deposited to form columns or other structures. In step 720, mask structure 711 has been removed in part and/or replaced with a thinner mask layer 721 of either the same or a different material as mask structure 711, leaving the columns 723 attached to the substrate structure 722. The columns 723 are partially exposed and available as conducting surfaces for subsequent electroplating. In step 730, a conductive material (possibly with different magnetic properties than 723) is applied so that the columns are now composites (called 733). Some of the above steps may be repeated to deposit additional layers. In step 740, another material is electrodeposited onto the columns 733, forming multi-layered columns 743. In Step 750, the columns 743 are separated from substrate 722. Additional conductive materials (with magnetic properties that may differ from prior layers) may be applied at this point. The substrate 742 may have been removed, either by etching, mechanical force application, filing, scraping or some other method.

It is understood that in operation 720, operation 730, and operation 740 sufficient material may be deposited onto columns 743 such that all columns 743 may be electrically connected together via continuously deposited metallic layers.

As disclosed in the invention by Weinberg “Apparatus and method for automated manufacturing of structures with electrically conductive segments”, U.S. patent application Ser. No. 17/860,426, incorporated by reference, the cavities may have a profile that is not uniform with depth, for example it may be narrower at the section of the cavity that is closest to the electrode structure. Such a profile may be used to subsequently create one or more structures 323 with features that may be narrower than the laser beam width used to create the cavity.

It is understood that the laser beam 200 forming the cavity may be tilted with respect to the mask structure to obtain a desired profile for the cavity, for example with eccentric walls. It is understood that said tilt may be affected through modification of the beam-forming components or by tilting the mask layer, or a combination of both.

It is understood that the mask layers of FIGS. 5-7 may be thin (for example, micron-sized) or thick (for example, millimeter or centimeter-sized) to result in macroscopic (e.g., centimeter or meter-scale) structures.

Technical innovations provided by the disclosed embodiments include: (1) Macroscopic magnetic structures are manufactured with nanoscale resolution, since the deposition processes can be controlled with such nanoscale resolution. (2) The surface area created by projections such as the columns of FIGS. 5-7 is high, and so the efficiency of deposition of multiple layers is increased significantly as compared to state of the art magnetic structures that are thin films. As an example, if each column was 2 microns wide and 10 mm tall, and the columns were 10 microns apart, and the surface deposition rate of magnetic material on each pillar's surface was one micron per minute, it would take about 4 minutes to fill the entire volume with magnetic material. On the other hand, if the surface deposition was to occur starting with a flat surface (i.e., without pillars), it would take 10,000 minutes to fill the entire volume.

It is understood that the role of the structures created using the disclosed embodiments may be to act as magnetic components in motors and generators.

It is understood that the ability to customize the composition of the magnetic structures using the methods and apparatus disclosed herein will allow the manufacturing of magnets with minimal or no need for rare earths that might be difficult to procure. It is understood that the nano scale control of composition allows the designer to take advantage of physical phenomena that are only observable in such small scales, for example exchange coupling between antiferromagnetic and ferrimagnetic materials (as discussed by Lottini et al) which can increase storage energy, or high energy product for samarium-cobalt-iron composites (as discussed by Yue et al) or other small-scale phenomena that may result in attractive bulk magnetic properties.

It is understood that narrow cavities can be drawn on the substrate by tilting the laser beam with respect to the mask structure. Tilting the substrate takes advantage of the shoulder of the laser beam profile, which can be wider or narrower than when the laser beam is perpendicular to the mask structure.

It is understood that non-conductive fluids may be deposited into the cavities. Covering the walls of the cavities with a conductive material before said deposition would allow a subsequent step of electrodeposition of a conductive layer to retain the non-conductive materials in the produced structure. Covering the walls of the cavities with a conductive material (whether or not non-conductive materials were deposited) would also allow a subsequent step of electrodeposition of a conductive layer to construct a wall or to increase wall thickness.

It is understood that at least one of the deposited materials may be magnetizable, and that preferential directions of magnetization during the production process may be created through application of a magnetic field or electric during some steps of the fabrication process.

It is understood that at least one of the deposited materials may be ferroelectric or magnetoferroic, and that preferential directions of magnetization or electrical polarization during the production process may be created through application of a magnetic or electrical field during the fabrication process. It is understood that at least one of the deposited materials may be antiferromagnetic or paramagnetic.

The mask layer by be made of polyimide, which has the attractive property of sublimating under laser or heat application.

It is understood that a heating element (for example a heating coil near an electrode structure) in the apparatus or a heating period may be included in method in order to cure fluids or anneal magnetic materials at some point during the production process.

It is understood that although for purposes of illustration, structures 120 and 130 are shown as separate structures, they may constitute one structure that has both mask properties and electrode properties in the same or different sections.

It is understood that steps in the methods described above may be repeated.

It is understood that the flat substrates illustrated in FIGS. 5-7 may be more generally replaced by non-flat surfaces, for example molds or other structures that may be generated by additive or other manufacturing processes, in which the surfaces are either electrically conductive or are coated with an electrically-conductive material.

It is understood that the magnetic properties of the structures produced with the disclosed embodiments will be dependent on the nature of the materials deposited and on the thicknesses and orientations of the structures constructed. For the purposes of this disclosure the term magnetic materials may include ferromagnetic materials, paramagnetic materials, anti-ferromagnetic materials, magnetically hard and magnetically soft materials. It is understood that the thicknesses of at least one of the materials will be less than one-micron, or less than 100 nanometers, or less than 10 nanometers, or less than 5 nanometers. It is understood that the magnetic properties of the structures produced with the disclosed embodiments may be due to interactions (for example exchange interactions) between various materials deposited to form the produced structure.

Moreover, those skilled in the art will recognize, upon consideration of the above teachings, that the above exemplary embodiments and the control system may be based upon use of one or more programmed processors programmed with a suitable computer program. However, the disclosed embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

Moreover, it should be understood that control and cooperation of the above-described components may be provided using software instructions that may be stored in a tangible, non-transitory storage device such as a non-transitory computer readable storage device storing instructions which, when executed on one or more programmed processors, carry out the above-described method operations and resulting functionality. In this case, the term “non-transitory” is intended to preclude transmitted signals and propagating waves, but not storage devices that are erasable or dependent upon power sources to retain information.

Those skilled in the art will appreciate, upon consideration of the above teachings, that the program operations and processes and associated data used to implement certain of the embodiments described above can be implemented using disc storage as well as other forms of storage devices including, but not limited to non-transitory storage media (where non-transitory is intended only to preclude propagating signals and not signals which are transitory in that they are erased by removal of power or explicit acts of erasure) such as for example Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies without departing from certain embodiments. Such alternative storage devices should be considered equivalents.

While various exemplary embodiments have been described above, it should be understood that they have been presented by way of example only, and not limitation. Thus, the breadth and scope of the present invention should not be limited by any of the above-described exemplary embodiments but should instead be defined only in accordance with the following claims and their equivalents.

What is claimed:

1. An apparatus for producing magnetic structures comprising:
an editing tool,
an editable structure in close proximity to an electrode structure, in which patterns are generated in the editable structure, wherein pattern generation accomplished at least in part by the editing tool, and wherein hollow portions in at least one of the generated patterns are filled entirely or partially by solid materials at least in part via electrodeposition from electrically conductive fluids, gases, or plasmas using the electrode structure as an electrode, and magnetic materials are deposited onto the solid materials, the, wherein magnetic materials constitute produced magnetic structures.

2. The apparatus of claim 1, wherein the editing tool is a laser.

3. The apparatus of claim 1, wherein the editing tool, editable structure, and the electrode structure are in a single container, and wherein a heating or magnetizing element is incorporated into the single container.

4. The apparatus of claim 1, where the magnetic structures are removable from the electrode structure.

5. The apparatus of claim 11, wherein the editing tool is a discharge-forming electrode.

6. The apparatus of claim 1, wherein the electrode structure contains titanium.

7. The apparatus of claim 1, wherein the editable structure contains polyimide.

8. The apparatus of claim 1, wherein at least one of the electrically conductive fluids contain surfactant.

9. The apparatus of claim 1, wherein fluids for electrodeposition are transported into and out of a single container containing the editable structure.

10. The apparatus of claim 1, wherein some of the deposited magnetic materials interact with other deposited magnetic materials via exchange interactions.

11. The apparatus of claim 1, wherein macroscopic magnetic structures are manufactured with nanoscale resolution, based on control of deposition processes via electrodeposition with nanoscale resolution, and wherein a surface area created by surfaces of the deposited solid materials is high, as compared to magnetic structures that are constructed as thin films.

12. A method for producing magnetic structures comprising:
generating patterns in an editable structure via an editing tool,
filling hollow portions in at least one of the patterns with solid materials,
wherein the filling is accomplished at least in part by electrodeposition from one or more conductive fluids, gases, or plasmas using an electrode structure in close proximity to the editable structure as an electrode, and subsequently depositing magnetic materials on the solid materials to produce structures containing magnetic materials.

13. The method of claim 12, wherein the editing tool, editable structure, and electrode structure are in a single container, and wherein the solid material and magnetic material fillings constitute the produced structures containing magnetic materials.

14. The method of claim 12, wherein the magnetic structures are removable from the electrode structure.

15. The method of claim 12, wherein the produced structures are composed at least in part of one or more of the following: metals, polymers, magnetizable materials, ferroelectric materials, paramagnetic materials, antiferromagnetic materials, magnetoferroic materials, or semiconductors.

16. The method of claim 12, wherein a depth profile of the editing tool results in produced structures with widths narrower than a width of the editing tool.

17. The method of claim 12, wherein the editing tool is a laser.

18. The method of claim 12, wherein the editing tool is a discharge-forming electrode.

19. The method of claim 12, further comprising applying annealing or curing, while the produced structures are in a container with the editing tool, editable structure, and electrode structure.

20. The method of claim 12, wherein the editable structure is deposited onto the electrode structure in a reel to reel process.

21. The method of claim 12, wherein magnetic or electrical fields are applied during the production method to magnetize or polarize one or more of the deposited materials.

22. The method of claim 12, wherein macroscopic magnetic structures are manufactured with nanoscale resolution, based on control of deposition processes via electrodeposition with nanoscale resolution, and wherein a surface area created by surfaces of the deposited solid materials is high, as compared to magnetic structures that are constructed as thin films.
